(19) United States
(12) Patent Application Publication
(10) Pub. No.: US 2021/0266328 A1
(43) Pub. Date: Aug. 26, 2021

(54) SYSTEM FOR GENERATING PLATFORM SPECIFIC PROTOCOLS FOR CONTROLLING CONDITIONAL RESOURCE DISTRIBUTION IN A DISTRIBUTED NETWORK ENVIRONMENT

(71) Applicant: BANK OF AMERICA CORPORATION, Charlotte, NC (US)

(72) Inventor: Yash Sharma, Delhi (IN)

(73) Assignee: BANK OF AMERICA CORPORATION, Charlotte, NC (US)

(21) Appl. No.: 16/800,173

(22) Filed: Feb. 25, 2020

(51) Int. Cl. H04L 29/06; H04L 29/08; G06F 9/50

(52) U.S. Cl. CPC H04L 63/104; H04L 67/1097; H04L 69/321; H04L 63/108; H04L 69/03; G06F 9/5011

(57) ABSTRACT

A system is provided for generating protocols for conditional resource distribution. The system is configured to: insert a validator node to the distributed trust computing network, the validator node being configured to execute and, with the decentralized nodes, verify resource transfers stored on the distributed register, the validator node being further configured to generate protocols for monitoring and executing conditional resource transfers; receive a request for a conditional resource transfer between a first storage location and a second storage location, the conditional resource transfer defining a condition for triggering the conditional resource transfer; in response to receiving the request, generate, via the validator node, a protocol for monitoring and executing the conditional resource transfer; determine, via the validator node, that the condition has been completed; and in response to the condition having been completed, execute the conditional resource transfer.

### BACKGROUND

Distributed network smart contract protocols are a growing, highly-adaptive new technology already being implemented across multiple industries. Due to the unique characteristics inherent to the distributed network environment structure and smart contract execution, the technology is able to provide unique security to executed processes and stored data. As such, there exists a need to implement distributed network environment and smart contract technology to improve electronic resource transfers between storage locations, and in particular, for conditional resource transfers.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

A system for generating protocols for conditional resource distribution is provided. The system comprises: a memory device with computer-readable program code stored thereon; a communication device connected to a distributed trust computing network comprising decentralized nodes that store a distributed register; and a processing device, wherein the processing device is configured to execute the computer-readable program code to: insert a validator node to the distributed trust computing network, the validator node being configured to execute and, with the decentralized nodes, verify resource transfers stored on the distributed register, the validator node being further configured to generate protocols for monitoring and executing conditional resource transfers; receive a request for a conditional resource transfer between a first storage location and a second storage location, the conditional resource transfer defining a condition for triggering the conditional resource transfer; in response to receiving the request, generate, via the validator node, a protocol for monitoring and executing the conditional resource transfer; determine, via the validator node, that the condition has been completed; and in response to the condition having been completed, execute the conditional resource transfer.

In one specific embodiment, the validator node is configured to generate a protocol in a platform language specific to the distributed trust computing network. In another embodiment, the distributed trust computing network is a permissioned network.

In yet another embodiment, the protocol is a smart contract deployed on the distributed register stored on the distributed trust computing network.

In yet another embodiment, the condition is a temporal condition, and wherein the validator node is configured to execute the conditional resource transfer after a predetermined amount of time.

In yet another embodiment, executing the conditional resource transfer comprises transferring a resource from the first storage location to the second storage location based on the condition having been completed, and wherein the validator node is further configured to store a portion of the resource until the condition has been completed. In yet another embodiment, storing the portion of the resources further comprises maintaining a minimum resource amount in the first storage location, wherein the minimum resource amount is at least equal to the stored portion of the resources for completing the conditional resource transfer after the condition has been completed.

In yet another embodiment, the condition is a first condition, wherein the conditional resource transfer further defines a second condition, and wherein the system modifies the conditional resource transfer based on the second condition being completed before the first condition. In yet another embodiment, modifying the conditional resource transfer comprises returning the portion of the resource to the first storage location. In yet another embodiment, the validator node is further configured to cancel a transfer of the portion of the resource based on the second condition being completed before the first condition. In yet another embodiment, the second condition is associated with a failure of a product associated with the resource transfer, wherein the failure of the product before completion of the first condition triggers returning the portion of the resource to the first storage location.

A computer-implemented method for generating protocols for conditional resource distribution is also provided. The computer-implemented method comprises: inserting a validator node to a distributed trust computing network, the validator node being configured to execute and, with decentralized nodes on the distributed trust computing network, verify resource transfers stored on a distributed register, the validator node being further configured to generate protocols for monitoring and executing conditional resource transfers; receiving a request for a conditional resource transfer between a first storage location and a second storage location, the conditional resource transfer defining a condition for triggering the conditional resource transfer; in response to receiving the request, generating, via the validator node, a protocol for monitoring and executing the conditional resource transfer; determining, via the validator node, that the condition has been completed; and in response to the condition having been completed, executing the conditional resource transfer.

In one specific embodiment, the validator node is configured to generate a protocol in a platform language specific to the distributed trust computing network. In another embodiment, the distributed trust computing network is a permissioned network.

In yet another embodiment, the protocol is a smart contract deployed on the distributed register stored on the distributed trust computing network.

In yet another embodiment, the condition is a temporal condition, and wherein the validator node is configured to execute the conditional resource transfer after a predetermined amount of time.

In yet another embodiment, executing the conditional resource transfer comprises transferring a resource from the first storage location to the second storage location based on the condition having been completed, and wherein the validator node is further configured to store a portion of the resource until the condition has been completed, wherein the condition is a first condition, wherein the conditional resource transfer further defines a second condition, and wherein the validator node modifies the conditional resource transfer based on the second condition being completed before the first condition

A computer program product for generating protocols for conditional resource distribution is also provided. The computer program product comprises a non-transitory computer-readable medium comprising computer-readable instructions, the computer-readable instructions, when executed by a processing device, cause the processing device to: insert a validator node to a distributed trust computing network, the validator node being configured to execute and, with decentralized nodes on the distributed trust computing network, verify resource transfers stored on a distributed register, the validator node being further configured to generate protocols for monitoring and executing conditional resource transfers; receive a request for a conditional resource transfer between a first storage location and a second storage location, the conditional resource transfer defining a condition for triggering the conditional resource transfer; in response to receiving the request, generate, via the validator node, a protocol for monitoring and executing the conditional resource transfer; determine, via the validator node, that the condition has been completed; and in response to the condition having been completed, execute the conditional resource transfer.

In one specific embodiment, the validator node is configured to generate a protocol in a platform language specific to the distributed trust computing network.

In another embodiment, executing the conditional resource transfer comprises transferring a resource from the first storage location to the second storage location based on the condition having been completed, and wherein the validator node is further configured to store a portion of the resource until the condition has been completed, wherein the condition is a first condition, wherein the conditional resource transfer further defines a second condition, and wherein the validator node modifies the conditional resource transfer based on the second condition being completed before the first condition.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a conditional resource distribution system environment, in accordance with one embodiment of the invention;

FIG. 2 provides a block diagram of a user device, in accordance with one embodiment of the invention;

FIG. 3 provides a block diagram of a conditional resource distribution system, in accordance with one embodiment of the invention;

FIG. 4 provides a block diagram of an entity system, in accordance with one embodiment of the invention;

FIG. 5 provides a block diagram of a validator node configuration within a distributed network environment, in accordance with one embodiment of the invention; and

FIG. 6 provides a high level process flow for conditional resource distribution through inserted smart contract protocols, in accordance with one embodiment of the invention.

### DETAILED DESCRIPTION OF EMBODIMENTS OF THE INVENTION

The system of the present invention is configured to facilitate implementation of resource transfers and conditional distributions between users within a distributed network environment infrastructure where the users maintain resource storage locations. In some embodiments, the system allows a first user to enter into a conditional resource transfer with a second user, wherein the terms of the conditional resource transfer control a resource release so as to only transfer a portion of a full resource amount initially. A remaining portion of the full resource amount may only be transferred upon one or more conditions being met. In a specific example, the resource transfer condition comprises a temporal component, wherein a full resource amount is only transferred after a predetermined amount of time.

In some embodiments, the aforementioned resource transfers are executed within a distributed network environment. The system inserts a validator node positioned on a distributed register configured for verifying and executing the resource transfer. The validator node is typically maintained by an entity associated with the system and is configured to monitor interactions and confirm or reject received resource transfers on the distributed register. The validator node provided by the system is configured to generate platform-specific protocols for executing requested resource transfers between users in the distributed network environment, wherein platform language-specific protocols are generated for the particular distributed network environment by the validator node.

In a specific embodiment, a protocol generated by the validator node is a smart contract configured to execute a conditional resource transfer between a first user and a second user. The smart contract protocol generated by the inserted validator node implements the protocol in the language of the specific distributed network environment and monitors each resource transfer as an associated distributed register shifts (e.g., additional entries to the register added). Furthermore, the validator node ensures that a resource amount associated with a first user does not drop below a predetermined threshold limit, thereby ensuring that the remainder of the resource transfer may be completed following the preestablished time period and/or other conditions. After a predetermined temporal condition and/or other conditions are met, the system (i.e., the validator node) is configured to automatically release the remaining or held portion of the resource amount to a second user resource location, thereby managing the extended resource release over time while providing an improved experience for both users.

Embodiments of the invention are directed to improvements in electronic resource transfer technology leveraging smart contract management and enforcement to determine rule-based, conditional resource transfer execution between storage locations as defined by generated platform-specific, smart contract protocols. The smart contracts may be configured to manage conditional resource transfers between resource storage locations, systems, or devices, wherein fulfillment of one or more transfer conditions trigger the resource transfers themselves as well as transfer details (i.e., resource transfer scheduling, number of resources transferred, and the like).

Embodiments of the present invention use distributed network environment, distributed register, and smart contract technologies in nonconventional, unexpected ways by leveraging the technologies to control and improve electronic resources transfers, and in particular, the execution of conditional resource transfers, wherein resources are conditionally held and/or transferred or leveraged between resource storage locations, systems, or devices. Distributed registers leveraging smart contract protocol technologies improve electronic resource transfers by increasing resource transfer security and granting independence from reliance on additional systems (e.g., third party systems) for transfer management and execution. Through the use of smart contracts in a distributed network environment, resource transfers may be performed credibly without the need for additional third parties. Furthermore, interactions executed according to the smart contract terms are secure, trackable, and irreversible.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

As used herein, the term “user” may refer to any entity or individual associated with the conditional resource distribution system. In some embodiments, a user may be a computing device user, a phone user, a mobile device application user, a customer of an entity or business, a system operator, and/or employee of an entity (e.g., a financial institution). In one embodiment, a user may be a customer accessing a user account via an associated user device, wherein data, funds, or other resources from an interaction between the user and an entity is received and processed by the system. In a specific embodiment, a user is an account user transferring resources in an interaction. In another specific embodiment, the resources are one or more of funds, goods, services and the like exchanged between a user and an entity in an interaction, wherein the resources are transferred between resource locations (e.g., accounts) for as specified by agreed upon transfer conditions. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, global positioning system (GPS) devices, gaming devices, or any combination of the aforementioned. The device may be used by the user to access the system directly or through an application, online portal, internet browser, virtual private network, or other connection channel. In a specific embodiment, a user device may refer to an automated teller machine (ATM) or point-of-sale device configured to receive and process a requested interaction or resource transfer.

As used herein, the term “entity” may be used to include any organization or collection of users that may interact with the conditional resource distribution system. An entity may refer to a business, company, or other organization that either maintains or operates the system or requests use and accesses the system. In one embodiment, the entity may be a financial entity. The terms “financial institution” and “financial entity” may be used to include any organization that processes resource transfers and/or other interaction including, but not limited to, banks, resource management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution.

As used herein, “authentication information” may refer to any information that can be used to authenticate an identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to at least partially authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system.

To “monitor” is to watch, observe, or check something for a special purpose over a period of time. The “monitoring” may occur periodically over the period of time, or the monitoring may occur continuously over the period of time. In some embodiments, a system may actively monitor a data source, data stream, database, or data archive, wherein the system reaches out to the database and watches, observes, or checks the database for changes, updates, and the like. In other embodiments, a system may passively monitor a database or data stream, wherein the database or data stream provides information to the system and the system then watches, observes, or checks the provided information. In some embodiments, “monitoring” may further comprise analyzing or performing a process on something such as a data source or data stream either passively or in response to an action or change in the data source or data stream. In another specific embodiment, monitoring may comprise determining completion of one or more conditions defined within a generated resource transfer for triggering a release or transfer of resources to a resource storage location.

As used herein, an “interaction” may refer to any action or communication between one or more users, one or more entities or institutions, and/or one or more devices or systems within the system environment described herein. For example, an interaction may refer to a user interaction with a system or device, wherein the user interacts with the system or device in a particular way. In one embodiment, interactions may be received or extracted from a data stream (e.g., in real-time). An interaction may include user interactions with a user interface of a user application (e.g., clicking, swiping, text or data entry, etc.), authentication actions (e.g., signing-in, username and password entry, PIN entry, etc.), account actions or events (e.g., account access, resource transfers, document or record views and/or transfers, etc.) and the like. In another example, an interaction may refer to a user communication via one or more channels (i.e., phone, email, text, instant messaging, brick-and-mortar interaction, and the like) with an entity and/or entity system to complete an operation or perform an action with an account associated with user and/or the entity. In a specific embodiment, an interaction may refer to a transfer or exchange of resource, goods, and/or service between users.

As used herein, the term “computing resource” may refer to elements of one or more computing devices, networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison). In some embodiments a “resource” may be used to refer to data, files, funds, goods, services, or the like. In some embodiments, a “resource” may also be used to refer to one or more computing resources.

The term “distributed register,” as used herein, may refer to a decentralized electronic ledger of data records which are authenticated by a federated consensus protocol. The distributed register is stored on a distributed trust computing network with a plurality of decentralized nodes. The multiple computer systems within the distributed register, referred to herein as “nodes” or “compute nodes,” each comprise a copy of the entire register of records. Nodes may write a data entry to the distributed register, the entry comprising data regarding a transaction, said entries further comprising data and/or metadata. In some embodiments, only miner nodes may write entries to the distributed register. In other embodiments, all nodes have the ability to write to the distributed register. In some embodiments, the entry may further comprise a time stamp and a pointer to the previous entry in the distributed register. In some embodiments, the entry may further comprise metadata indicating the node that was the originator of the interaction. In this way, the entire record of interactions is not dependent on a single database which may serve as a single point of failure; the distributed register will persist so long as the nodes on the distributed register persist. A “private” distributed register or “permissioned” distributed register is a distributed register in which only authorized nodes may access the distributed register. In some embodiments, nodes must be authorized to write to the distributed register. In some embodiments, nodes must also be authorized to read from the distributed register. Once a record is written to the distributed register, it will be considered pending and awaiting authentication by the miner nodes in the distributed register.

An “entry” as used herein may refer to one or more records of a file with each record comprising data for transmission to a server. In some embodiments, the term record may be used interchangeably with the term entry to refer to one or more interactions or data within a file being transmitted. In particular, the distributed register begins with a genesis entry or record and is subsequently lengthened by appending entries in series to the genesis entry. Generally, the data within each entry within the distributed register may not be modified by the nodes of the distributed register; data may only be added through the addition of an entry to the last entry in the distributed register. Each entry added to the distributed register may comprise a timestamp and a pointer to the previous entry in the distributed register. In this way, the distributed register may provide an immutable record of data records over a period of time. In some embodiments, in order for a new entry to be added to the distributed register, a pending data entry or record may be proposed to be added to the distributed register. The nodes may then, via a “consensus algorithm” or “consensus mechanism,” come to a consensus as to the contents of the data in the distributed register. Once a consensus has been reached by the nodes that the pending data record is valid, the nodes append the data record to the last entry in the distributed register. In this way, each node maintains a validated copy of the distributed register such that the distributed register may remain accessible even if one or more nodes become unavailable (e.g. a node is offline due to maintenance, malfunction, etc.) and may further account for divergence from the true copy of the distributed register which may occur at the node level (e.g. a copy of the distributed register on a particular node becomes invalid due to data corruption, malicious editing, and the like). In other words, the consensus mechanism ensures that, over time, each node hosts a copy of the distributed register that is consistent with the other nodes.

The term “smart contract,” as used herein, refers to a computer process, protocol, algorithm, or portion of code established to facilitate, verify, and/or enforce negotiation or performance of a contract (e.g., a resource transfer) between parties. Operations or interactions executed according to a smart contract may be performed credibly without additional third parties. When implemented on a distributed register within a distributed network environment on a collection of nodes, the operations or interactions executed according to the smart contract terms are secure, trackable, and irreversible, thereby providing improved interaction security over traditional interaction execution methods. Smart contract protocols include logic that emulate contractual clauses that are partially or fully self-executing and/or self-enforcing. The smart contracts provide guidelines for the transfer of data or other resources (e.g., funds) between users as well as rules or conditions for executing interactions. The smart contracts may further define consensus (e.g., proof of work) and encryption mechanisms for the information or data of an interaction (e.g., user identifying information). In one embodiment, smart contracts are configured to conditionally transfer resources between user storage locations based on one or more predetermined requirements or contractual agreements between the users (e.g., temporal requirement or, time limits).

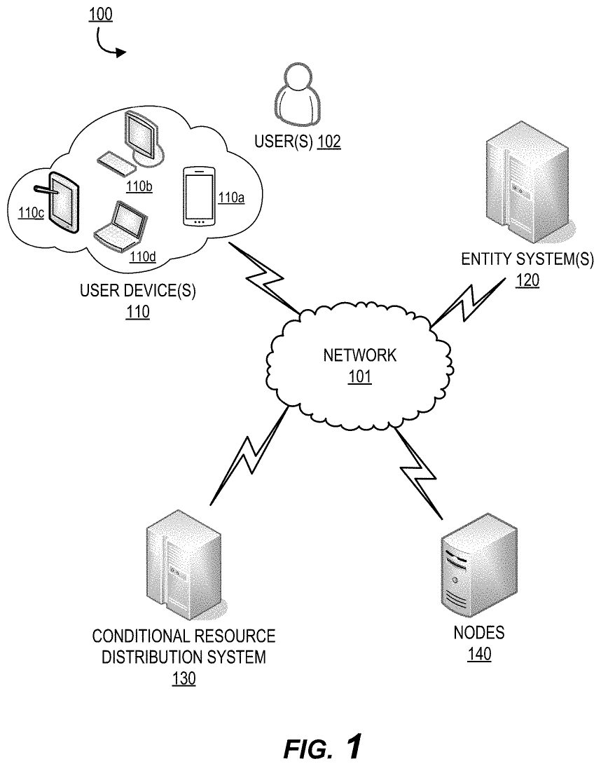

FIG. 1 provides a system that includes specialized systems and devices communicably linked across a distributed network of nodes required to perform the functions of implementing the conditional resource transfer system as described herein. FIG. 1 provides a conditional resource distribution system environment, in accordance with one embodiment of the invention. As illustrated in FIG. 1, the conditional resource distribution system 130 is operatively coupled, via a network 101 to one or more user devices 110 (e.g., a plurality of user devices 110a-110d), nodes 140, and the entity system 120. In this way, the conditional resource distribution system 130 can send information to and receive information from the user device 110, nodes 140, and entity system 120. In the illustrated embodiment, the plurality of user devices 110a-110d provide a plurality of communication channels through which the entity system 120 and/or the conditional resource distribution system 130 may communicate with the user 102 over the network 101.

FIG. 1 illustrates only one example of an embodiment of the system environment 100, and it will be appreciated that in other embodiments one or more of the systems, devices, or servers may be combined into a single system, device, or server, or be made up of multiple systems, devices, or servers. It should be understood that the servers, systems, and devices described herein illustrate one embodiment of the invention. It is further understood that one or more of the servers, systems, and devices can be combined in other embodiments and still function in the same or similar way as the embodiments described herein.

The network 101 may be a system specific distributed network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual interacting with one or more entity systems 120 via a user device 110 while a data flow between the user device 110 and the entity system 120 is intercepted and monitored by the conditional resource distribution system 130 over the network 101. In some embodiments a user 102 is a user requesting service from the entity or interacting with an account maintained by the entity system 120. In an alternative embodiment, the user 102 is an individual interacting with the conditional resource distribution system 130 over the network 101 and monitoring input of information from the entity systems 120 to the conditional resource distribution system 130 for processing and analysis (e.g., an employee of the entity operating and/or monitoring the systems 120, 130). In yet another embodiment, the user 102 is a first user interacting with a second user to complete a resource transfer between the first user and the second user, wherein resources may be stored and/or maintained by the entity system 120 for one or more of the users 102.

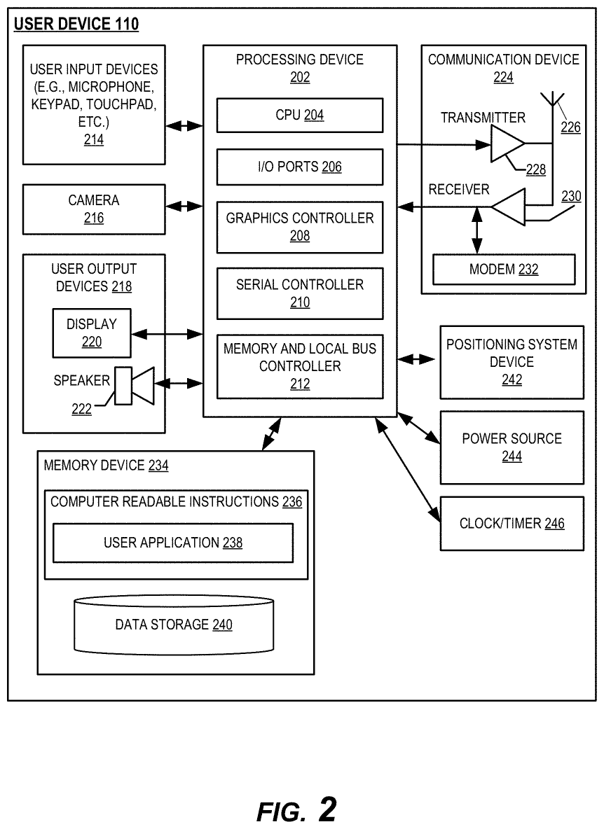

FIG. 2 provides a block diagram of a user device 110, in accordance with one embodiment of the invention. The user device 110 may generally include a processing device or processor 202 communicably coupled to devices such as, a memory device 234, user output devices 218 (e.g., a user display device 220, or a speaker 222), user input devices 214 (e.g., a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like. In one embodiment, the camera 216 may include a scanner, barcode reader, or any other image capturing device configured to capture an image or collect data from a hardcopy record or document. The processing device 202 may further include a central processing unit 204, input/output (I/O) port controllers 206, a graphics controller or graphics processing device (GPU) 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems of the environment 100. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with other systems such as the entity system 120. In some embodiments, the user is a customer of a financial entity and the user application 238 is a resource management application providing access to a resource storage location maintained by the entity system 120 wherein the user may interact with the resource storage location via a user interface of the user application 238. In one embodiment, the user application 238 may be configured to allow a user 102 to request and/or accept a resource transfer with another user, user device, or entity.

The processing device 202 may be configured to use the communication device 224 to communicate with one or more other devices on a network 101 such as, but not limited to the entity system 120, the conditional resource distribution system 130, nodes 140, and/or the. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 101. In this regard, the user device 110 may be configured to operate with one or more air interface standards, communication protocols, modulation types, and access types. By way of illustration, the user device 110 may be configured to operate in accordance with any of a number of first, second, third, fourth, and/or fifth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processing device 202. Typically, the one or more applications 238, are loaded into the temporarily memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

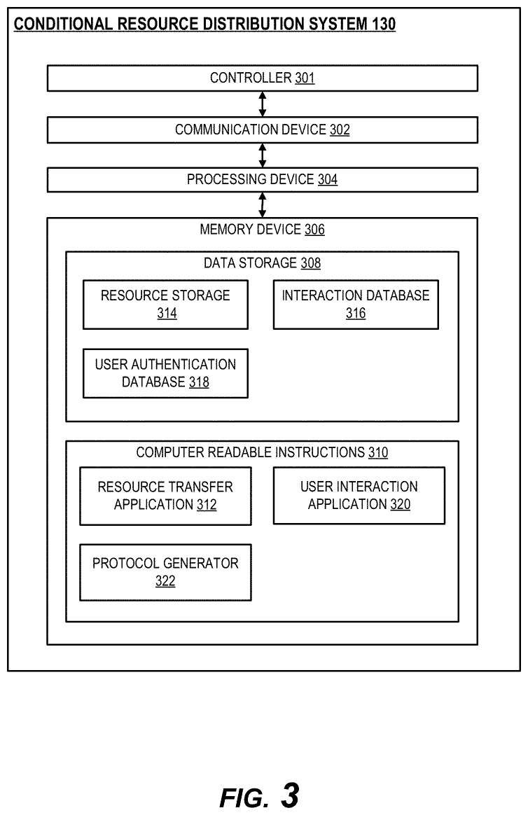

FIG. 3 provides a block diagram of a conditional resource distribution system 130, in accordance with one embodiment of the invention. The conditional resource distribution system 130 generally comprises a controller 301, a communication device 302, a processing device 304, and a memory device 306.

As used herein, the term “controller” generally refers to a hardware device and/or software program that controls and manages the various systems described herein such as the user device 110, the entity system 120, the nodes 140, and/or the conditional resource distribution system 130, in order to interface and manage data flow between systems while executing commands to control the systems. In some embodiments, the controller may be integrated into one or more of the systems described herein. In other embodiments, the controller may be a separate system or device. In some embodiments, the controller may perform one or more of the processes, actions, or commands described herein.

As used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 304 is operatively coupled to the communication device 302 and the memory device 306. The processing device 304 uses the communication device 302 to communicate with the network 101 and other devices on the network 101, such as, but not limited to the user device 110, the entity system 120, and nodes 140. As such, the communication device 302 generally comprises a modem, server, or other device for communicating with other devices on the network 101.

As further illustrated in FIG. 3, the conditional resource distribution system 130 comprises computer-readable instructions 310 stored in the memory device 306, which in one embodiment includes the computer-readable instructions 310 of a resource transfer application 312, a user interaction application 320, and a protocol generator 322. The resource transfer application 312 is configured to receive and execute resource transfer requests between users, wherein resource may be directed between resource storage locations of one or more user devices. In one embodiment, the resource transfer application 312 is configured to monitor for one or more predefined resource transfer conditions, wherein upon completion or execution of the one or more conditions, the associated resources may be transferred. In yet another embodiment, the resource transfer application 312 is configured to hold resources in resource storage 314 as required by the defined conditions of a resource transfer request. The user application interaction 320 is configured to bridge communication between the system 130, application 312, and the user device 110. The protocol generator 322 is configured to generate one or more executable computer protocols (e.g., smart contracts) for completing conditional resource transfers. In one embodiment, the protocol generator 322 is configured to generate a protocol in a computing language specific to a deployed environment.

In some embodiments, the memory device 306 includes data storage 308 for storing data related to the system environment, but not limited to data created and/or used by the file processing application 312, user interaction application 320, and the protocol generator 322. Data stored in the data storage 308 may comprise resource storage 314, an interaction database 316, and a user authentication database 318.

File storage 314 is used to store resources based upon conditions defined by a conditional resource request. While the resource storage 314 is shown in FIG. 3 as part of the conditional resource distribution system 130, in other embodiments, resource storage may be included on one or more other systems (e.g., user device 110, entity systems 120) to supplement or as an alternative to resource storage 314 on the conditional resource distribution system 130. In one embodiment, resources are stored on the user device 110 or entity systems 120, wherein the conditional resource distribution system 130 pulls the resources from user device or the entity systems 120 when the defined conditions of a resource transfer are met. The conditional resource distribution system 130 may intercept and monitor resources transferred between one or more user devices 110 before the resources are ultimately sent to and/or routed by an entity system 120 to complete a resource transfer.

The interaction database 316 is used to store information regarding past interactions (e.g., resource transfers) during a session (e.g., an online banking session) with the user 102. In some embodiments, the interaction database 316 may be configured to store data from an incoming data stream in real-time. The interaction database 316 may further include information or data related to the interactions such as user data, resource transfer history, and the like. The system may be configured to access and update stored information and data stored in the interaction database 316 as additional information is collected.

In one embodiment of the invention, the conditional resource distribution system 130 may associate with applications having computer-executable program code that instruct the processing device 304 to perform certain functions described herein. In one embodiment, the computer-executable program code of an application associated with the user device 110 and/or the entity systems 120 may also instruct the processing device 304 to perform certain logic, data processing, and data storing functions of the application.

Embodiments of the conditional resource distribution system 130 may include multiple systems, servers, computers or the like maintained by one or many entities. In some embodiments, the conditional resource distribution system 130 may be part of and/or maintained by the entity systems 120. In other embodiments, the entity systems 120 are distinct from the conditional resource distribution system 130. The conditional resource distribution system 130 may communicate with the entity systems 120 via a secure connection generated for secure encrypted communications between the two systems either over the network 101 or alternative to the network 101.

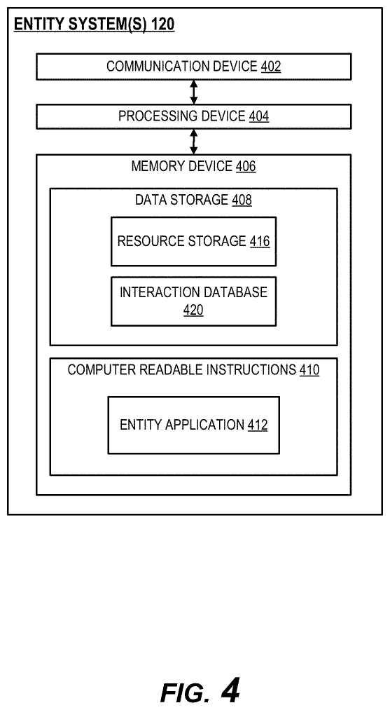

As illustrated in detail in FIG. 4, the environment 100 further includes one or more entity systems 120 which are connected to the user device 110, conditional resource distribution system 130, the nodes 140. The entity systems 120 may be associated with one or more entities, institutions or the like. The entity systems 120 generally comprise a communication device 402, a processing device 404, and a memory device 406 further comprising data storage 408. The entity systems 120 comprise computer-readable instructions 410 stored in the memory device 406, which in one embodiment includes the computer-readable instructions of an entity application 412. The entity systems 120 may communicate with the user device 110, the conditional resource distribution system 130, and nodes 140 to provide access to resources and resource storage locations stored and maintained on the entity systems 120. In some embodiments, the entity system 120 may communicate with the conditional resource distribution system 130 during an interaction (e.g., a resource transfer) with a user 102 in real-time, wherein user interactions may be monitored and processed by the conditional resource distribution system 130. In some embodiments, data storage 408 comprises resource storage 416 and/or interaction database 420 to either supplement or replace the resource storage 314 and/or interaction database 316 of the conditional resource distribution system 130 as previously discussed.

The system of the present invention is configured to facilitate implementation of resource transfers and conditional distributions between users within a distributed network environment infrastructure where the users maintain resource storage locations. In some embodiments, the system allows a first user to enter into a conditional resource transfer with a second user, wherein the terms of the conditional resource transfer control a resource release so as to only transfer a portion of a full resource amount initially. A remaining portion of the full resource amount may only be transferred upon one or more conditions being met. In a specific example, the resource transfer condition comprises a temporal component, wherein a full resource amount is only transferred after a predetermined amount of time.

In some embodiments, the aforementioned resource transfers are executed within a distributed network environment. The system inserts a validator node positioned on a distributed register configured for verifying and executing the resource transfer. The validator node is typically maintained by an entity associated with the system and is configured to monitor interactions and confirm or reject received resource transfers on the distributed register. The validator node provided by the system is configured to generate platform-specific protocols for executing requested resource transfers between users in the distributed network environment, wherein platform language-specific protocols are generated for the particular distributed network environment by the validator node.

In a specific embodiment, a protocol generated by the validator node is a smart contract configured to execute a conditional resource transfer between a first user and a second user. The smart contract protocol generated by the inserted validator node implements the protocol in the language of the specific distributed network environment and monitors each resource transfer as an associated distributed register shifts (e.g., additional entries to the register added). Furthermore, the validator node ensures that a resource amount associated with a first user does not drop below a predetermined threshold limit, thereby ensuring that the remainder of the resource transfer may be completed following the preestablished time period and/or other conditions. After a predetermined temporal condition and/or other conditions are met, the system (i.e., the validator node) is configured to automatically release the remaining or held portion of the resource amount to a second user resource location, thereby managing the extended resource release over time while providing an improved experience for both users.

Embodiments of the invention are directed to improvements in electronic resource transfer technology leveraging smart contract management and enforcement to determine rule-based, conditional resource transfer execution between storage locations as defined by generated platform-specific, smart contract protocols. The smart contracts may be configured to manage conditional resource transfers between resource storage locations, systems, or devices, wherein fulfillment of one or more transfer conditions trigger the resource transfers themselves as well as transfer details (i.e., resource transfer scheduling, number of resources transferred, and the like).

Embodiments of the present invention use distributed network environment, distributed register, and smart contract technologies in nonconventional, unexpected ways by leveraging the technologies to control and improve electronic resources transfers, and in particular, the execution of conditional resource transfers, wherein resources are conditionally held and/or transferred or leveraged between resource storage locations, systems, or devices. Distributed registers leveraging smart contract protocol technologies improve electronic resource transfers by increasing resource transfer security and granting independence from reliance on additional systems (e.g., third party systems) for transfer management and execution. Through the use of smart contracts in a distributed network environment, resource transfers may be performed credibly without the need for additional third parties. Furthermore, interactions executed according to the smart contract terms are secure, trackable, and irreversible.

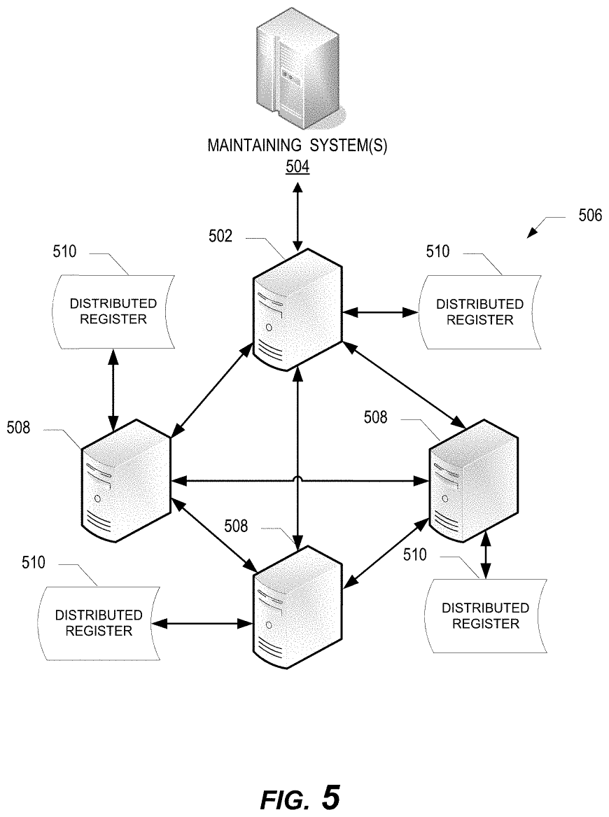

FIG. 5 provides a block diagram of a validator node configuration within a distributed network environment, in accordance with one embodiment of the invention. As illustrated in FIG. 5 a validator node 502 is inserted by the system 504 into a distributed network environment 506 comprising one or more additional nodes 508 having access to a distributed register 510. The validator node 502 is maintained by a system 504 (e.g., conditional resource distribution system 130 and/or entity system 120) and configured to generate protocols for executing requested conditional resource transfers within the distributed network environment 606. In one embodiment, the validator node 502 is a computing system maintained by an entity system 102 and inserted into the distributed trust computing network comprising the decentralized nodes 508 that store a distributed register comprising entries related to one or more conditional resource transfers.

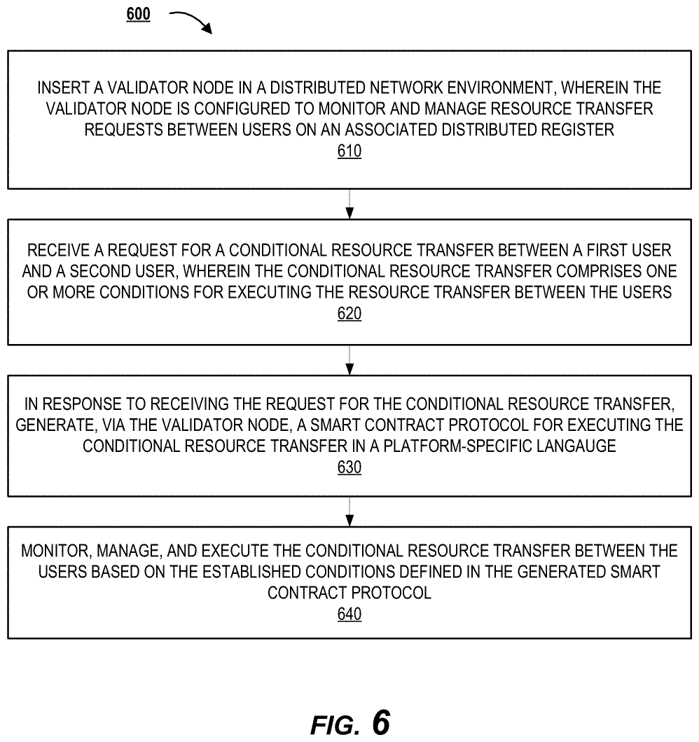

FIG. 6 provides a high level process flow for conditional resource distribution through inserted protocols (e.g., smart contract protocols), in accordance with one embodiment of the invention. As used herein, a “protocol” or a “computing protocol” is a set of rules, procedures, tasks, or the like defining a transmission of data between electronic devices (e.g., user devices). The protocol is configured to be executed by one or more computing devices, for example, via processor. The protocol acts as a predefined agreement between devices for controlling how data is exchanged, structured, sent, received, and the like. In a specific example, a protocol may define a number of bits required to be included in a transmitted packet or another requirement specific to a particular computing platform format and/or language for defining a required data output or other instructions.

As previously discussed, in one embodiment, the system of the invention is configured to operate on a distributed trust computing network comprising a plurality of decentralized nodes storing a distributed register thereon. In a specific embodiment, the distributed register comprises one or more resource transfers. In another embodiment, the distributed trust computing network is a permissioned network, wherein only authorized and/or authenticated nodes (e.g., nodes 140) are permitted to participate on the network to access and verify the distributed register. In an alterative embodiment, the network is a public or semi-permissioned network. As illustrated in block 610, the system is configured to first insert a validator node to a distributed network environment, wherein the validator node is configured to monitor, manage, and execute resource transfer requests between users on an associated distributed register. In some embodiment, the validator node is configured to verify entries stored on the distributed register related to resource transfers along with the decentralized nodes.

As illustrated in block 620, the system is configured to receive a request for a conditional resource transfer between a first user and a second user, wherein the conditional resource transfer defines a transfer of one or more resources between resource storage locations (e.g., from a first resource storage location to a second resource storage location). In one embodiment, a request for a resource transfer may include a transaction or interaction between two users for an exchange of resources, goods, services, or the like. For example, a first user (i.e., a customer) may request a purchase of products, goods, and/or services from a second user (e.g., a business, merchant, or the like). In some embodiments, the request may be an electronic communication transmitted from a user device such as a point-of-sale device or the like that is received by the system.

A conditional resource transfer further comprises one or more conditions for triggering completion of a resource transfer (e.g., a release of resources to a recipient) and/or execution of one or more other actions associated with the resource transfer (e.g., intermediate steps before release of resources). In a specific embodiment, the one or more conditions may comprise a temporal condition component, wherein a resource is only transferred after a predetermined period of time. In another example, a condition may be event based, wherein the resource transfer is dependent on an action, occurrence, or the like performed by at least one of the users and/or goods or services associated with the resource transfer. In a specific example, an event that triggers a predefined condition of the resource transfer may include failure of a product exchanged for another resource between users.

As illustrated in block 630, in response to receiving the request for the conditional resource transfer, the validator node of the system is configured to generate a protocol for executing the conditional resource transfer. In one embodiment, the protocol is generated in a platform-specific language tailored for the specific distributed network environment. For example, the platform of a particular distributed network environment may be based on a specific and/or proprietary computing language, wherein only properly formatted protocols may be executed with the network environment. In one embodiment, the validator node may be configured to generate the protocol at the time of the request in real-time.

In a specific embodiment of the invention, the platform of the system comprises a statically-typed programming language, wherein variable types are explicitly defined and determined at time of compilation. In this way, type checking can be performed during a compiling stage instead of a run-time to increase program run-time performance. In some embodiments, the programming language of the system is compiled to bytecode or another intermediate code form between source code and machine language or code. The intermediate code (e.g., bytecode) may comprise compact code portions that may be processed by software and are executable on hardware or virtual machines. In some embodiments, use of an intermediate code allows for the same code portions to run across a variety of platforms while reducing dependence on hardware or operating systems. In a specific embodiment, an intermediate code portion may be further compiled into a specific machine code for a particular platform or computing language. In this way, the system is configured to use the platform-agnostic intermediate format to readily generate protocols for a specific platform environment.

In another embodiment, the generated protocol is a smart contract configured for executing the conditional resource transfer between the users in the distributed network environment. Distributed registers leveraging smart contract protocol technologies improve electronic resource transfers by increasing resource transfer security and granting independence from reliance on additional systems (e.g., third party systems) for transfer management and execution. Through the use of smart contracts in a distributed network environment, resource transfers may be performed credibly without the need for additional third parties. Furthermore, interactions executed according to the smart contract terms are secure, trackable, and irreversible.

As illustrated in block 640, the system, and specifically the inserted validator node, is configured to monitor, manage, and execute the conditional resource transfer between the users. The validator node is configured to determine whether one or more of the conditions defined in the conditional resource transfer and generated protocol have been completed. In response to determining that one or more required conditions have been completed the system is configured to execute the conditional resource transfer thereby releasing the resource to a destination resource storage location.

In one embodiment, the validator node is configured to operate and execute the resource transfer according to the established smart contract protocol, wherein resources are transferred from a first storage location to a second storage location based on the one or more defined conditions. In some embodiments, the conditions may restrict a transfer of at least a portion of the transferred resources based on the one or more conditions. The system may be configured to hold a portion of the transferred resources (e.g., in resource storage 314) until one or more predefined conditions are met or otherwise completed. For example, a portion of the resource may be held for a predetermined amount of time before being released in full to a resource storage location associated with a recipient. In this way, a conditional agreement or contract between users may be enforced through the impartial control of the validator node that is configured to temporarily hold at least a portion of the resources until one or more conditions are completed.

In a specific embodiment, storing the portion of the resources further comprises maintaining a minimum resource amount in the first storage location, wherein the minimum resource amount is at least equal to the stored portion of the resources for completing the conditional resource transfer after the condition has been completed. By allowing the system to maintain the minimum amount in the resource storage location, the system may ensure that a requested resource transfer may be completed should the one or more conditions of the defined resource transfer be met. Stated another way, an agreed upon resource amount is guaranteed to be transferred between users thereby improving confidence in the integrity of resource transfer system.

In some embodiments, a conditional resource transfer may comprise more than one condition, wherein additional conditions may trigger modifications to the resource transfer for alternatively completing the agreement. In one example, completion of a first condition triggers completion of the resource transfer, wherein the resource is transferred from a first user to a second user. Alternatively, completion of a second condition modifies the conditional resource transfer and triggers a return of a resource to the first user. In this embodiment, the completion of the conditional resource transfer is dependent on which of the predefined conditions is completed first.

In a specific example, a conditional resource transfer is requested between a first user and a second user, wherein the first user is a customer, and the second user is a business or merchant. The first user is transferring resources to the second user in exchange for a product, good, service, or the like. In this example, the conditional resource transfer defines a first condition wherein a portion of the resources are held by the system for a predetermined period of time, wherein after the predetermined period of time, the portion of the resources is released to the second user. A second, alternative condition is also defined, wherein, the portion of resources is instead returned to the first user should the purchased product, goods, or service fail, malfunction, or the like before the predetermined period of time of the first condition is complete. In response, a validator node generates a smart contract protocol for executing the conditional resource transfer between the users according to the defined conditions, wherein the resource is directed to a resource storage location depending on the conditions met.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with electronic resource transfers by incorporating smart contract protocol technology in a distributed network environment.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for implementing smart contract protocols for executing conditional resource transfers, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generating protocols for conditional resource distribution, the system comprising:
a memory device with computer-readable program code stored thereon;
a communication device connected to a distributed trust computing network comprising decentralized nodes that store a distributed register; and
a processing device, wherein the processing device is configured to execute the computer-readable program code to:
insert a validator node to the distributed trust computing network, the validator node being configured to execute and, with the decentralized nodes, verify resource transfers stored on the distributed register, the validator node being further configured to generate protocols for monitoring and executing conditional resource transfers;
receive a request for a conditional resource transfer between a first storage location and a second storage location, the conditional resource transfer defining a condition for triggering the conditional resource transfer;
in response to receiving the request, generate, via the validator node, a protocol for monitoring and executing the conditional resource transfer;
determine, via the validator node, that the condition has been completed; and
in response to the condition having been completed, execute the conditional resource transfer.

2. The system of claim 1, wherein the validator node is configured to generate the protocol in a platform language specific to the distributed trust computing network.

3. The system of claim 2, wherein the distributed trust computing network is a permissioned network.

4. The system of claim 1, wherein the protocol is a smart contract deployed on the distributed register stored on the distributed trust computing network.

5. The system of claim 1, wherein the condition is a temporal condition, and wherein the validator node is configured to execute the conditional resource transfer after a predetermined amount of time.

6. The system of claim 1, wherein executing the conditional resource transfer comprises transferring a resource from the first storage location to the second storage location based on the condition having been completed, and wherein the validator node is further configured to store a portion of the resource until the condition has been completed.

7. The system of claim 6, wherein storing the portion of the resource further comprises maintaining a minimum resource amount in the first storage location, wherein the minimum resource amount is at least equal to the stored portion of the resource for completing the conditional resource transfer after the condition has been completed.

8. The system of claim 6, wherein the condition is a first condition, wherein the conditional resource transfer further defines a second condition, and wherein the system modifies the conditional resource transfer based on the second condition being completed before the first condition.

9. The system of claim 8, wherein modifying the conditional resource transfer comprises returning the portion of the resource to the first storage location.

10. The system of claim 9, wherein the validator node is further configured to cancel a transfer of the portion of the resource based on the second condition being completed before the first condition.

11. The system of claim 9, wherein the second condition is associated with a failure of a product associated with the resource transfer, wherein the failure of the product before completion of the first condition triggers returning the portion of the resource to the first storage location.

12. A computer-implemented method for generating protocols for conditional resource distribution, the computer-implemented method comprising:
inserting a validator node to a distributed trust computing network, the validator node being configured to execute and, with decentralized nodes on the distributed trust computing network, verify resource transfers stored on a distributed register, the validator node being further configured to generate protocols for monitoring and executing conditional resource transfers;
receiving a request for a conditional resource transfer between a first storage location and a second storage location, the conditional resource transfer defining a condition for triggering the conditional resource transfer;
in response to receiving the request, generating, via the validator node, a protocol for monitoring and executing the conditional resource transfer;
determining, via the validator node, that the condition has been completed; and
in response to the condition having been completed, executing the conditional resource transfer.

13. The computer-implemented method of claim 12, wherein the validator node is configured to generate the protocol in a platform language specific to the distributed trust computing network.

14. The computer-implemented method of claim 13, wherein the distributed trust computing network is a permissioned network.

15. The computer-implemented method of claim 12, wherein the protocol is a smart contract deployed on the distributed register stored on the distributed trust computing network.

16. The computer-implemented method of claim 12, wherein the condition is a temporal condition, and wherein the validator node is configured to execute the conditional resource transfer after a predetermined amount of time.

17. The computer-implemented method of claim 12, wherein executing the conditional resource transfer comprises transferring a resource from the first storage location to the second storage location based on the condition having been completed, and wherein the validator node is further configured to store a portion of the resource until the condition has been completed, wherein the condition is a first condition, wherein the conditional resource transfer further defines a second condition, and wherein the validator node modifies the conditional resource transfer based on the second condition being completed before the first condition.

18. A computer program product for generating protocols for conditional resource distribution, wherein the computer program product comprises a non-transitory computer-readable medium comprising computer-readable instructions, the computer-readable instructions, when executed by a processing device, cause the processing device to:
insert a validator node to a distributed trust computing network, the validator node being configured to execute and, with decentralized nodes on the distributed trust computing network, verify resource transfers stored on a distributed register, the validator node being further configured to generate protocols for monitoring and executing conditional resource transfers;
receive a request for a conditional resource transfer between a first storage location and a second storage location, the conditional resource transfer defining a condition for triggering the conditional resource transfer;
in response to receiving the request, generate, via the validator node, a protocol for monitoring and executing the conditional resource transfer;
determine, via the validator node, that the condition has been completed; and
in response to the condition having been completed, execute the conditional resource transfer.

19. The computer program product of claim 18, wherein the validator node is configured to generate the protocol in a platform language specific to the distributed trust computing network.

20. The computer program product of claim 18, wherein executing the conditional resource transfer comprises transferring a resource from the first storage location to the second storage location based on the condition having been completed, and wherein the validator node is further configured to store a portion of the resource until the condition has been completed, wherein the condition is a first condition, wherein the conditional resource transfer further defines a second condition, and wherein the validator node modifies the conditional resource transfer based on the second condition being completed before the first condition.
